(19) United States
(12) Patent Application Publication
(10) Pub. No.: US 2026/0098982 A1
(43) Pub. Date: Apr. 9, 2026

(54) WIRE NODULE DETECTION DEVICE

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 19/351,403

(22) Filed: Oct. 7, 2025

(30) Foreign Application Priority Data
Oct. 9, 2024 (CN) 202411411278.8

(51) Int. Cl. G01V 8/12

(52) U.S. Cl. CPC G01V 8/12

(57) ABSTRACT

A wire nodule detection device includes a rotating wheel, a swing arm having a pressing portion pressing a conveyed wire against the rotating wheel, and a sensor detecting a position of the swing arm. When a nodule on the conveyed wire passes between the rotating wheel and the pressing portion of the swing arm, the swing arm swings between a first position and a second position. A presence of the nodule on the conveyed wire is determined based on the position detected by the sensor.

### CROSS-REFERENCE TO RELATED APPLICATIONS

This application claims the benefit of the filing date under 35 U.S.C. § 119 (a)-(d) of Chinese Patent Application No. 202411411278.8, filed on Oct. 9, 2024.

### FIELD OF THE INVENTION

The present invention relates to a wire nodule detection device.

### BACKGROUND

Nodules easily occur during the production and manufacturing of wires. The size of the wire nodules is larger than the diameter of the wire, which can lead to problems such as blockage during the conveying of the wire. For example, the wire nodules may block wire through-holes, preventing the wire from passing through the wire through-holes smoothly and causing production failures.

### SUMMARY

A wire nodule detection device includes a rotating wheel, a swing arm having a pressing portion pressing a conveyed wire against the rotating wheel, and a sensor detecting a position of the swing arm. When a nodule on the conveyed wire passes between the rotating wheel and the pressing portion of the swing arm, the swing arm swings between a first position and a second position. A presence of the nodule on the conveyed wire is determined based on the position detected by the sensor.

### BRIEF DESCRIPTION OF DRAWINGS

In the following, the present invention is described in more detail with reference to the drawings in which:

FIG. 1 shows an illustrative perspective view of a wire nodule detection device according to an exemplary embodiment of the present invention, with a swing arm in a first position;

FIG. 2 shows an illustrative plan view of the wire nodule detection device according to an exemplary embodiment of the present invention, with the swing arm in the first position;

FIG. 3 shows an illustrative perspective view of the wire nodule detection device according to an exemplary embodiment of the present invention, with the swing arm in a second position; and

FIG. 4 shows an illustrative plan view of the wire nodule detection device according to an exemplary embodiment of the present invention, with the swing arm in the second position.

### DETAILED DESCRIPTION OF THE EMBODIMENTS

The technical solution of the present invention is further specifically described below by way of embodiments and in conjunction with the accompanying drawings. In the specification, the same or similar accompanying drawing symbols indicate the same or similar components. The following description of the embodiments of the present invention with reference to the accompanying drawings is intended to explain the general inventive concept of the present invention and should not be construed as a limitation of the present invention.

In addition, the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

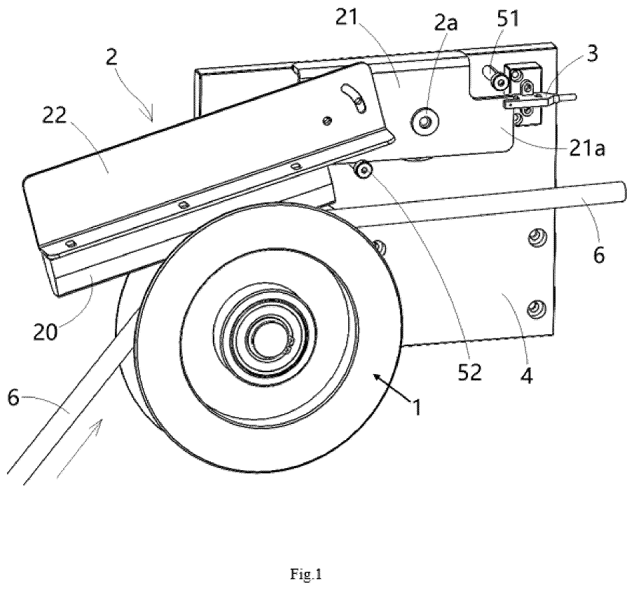

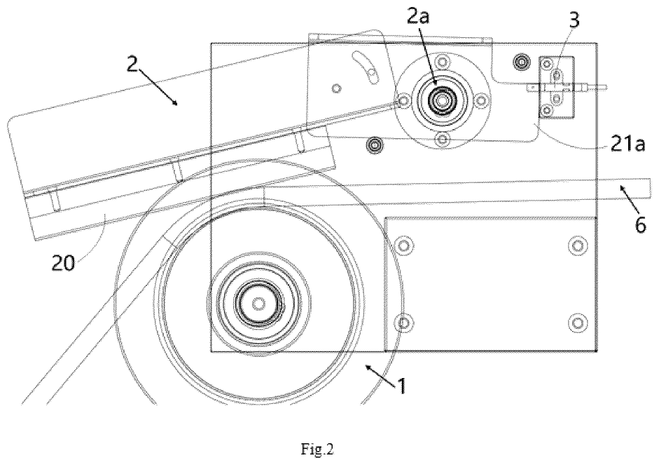

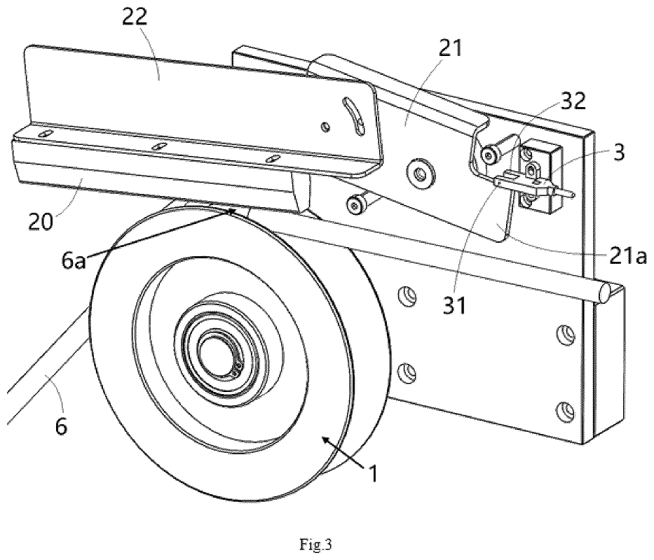

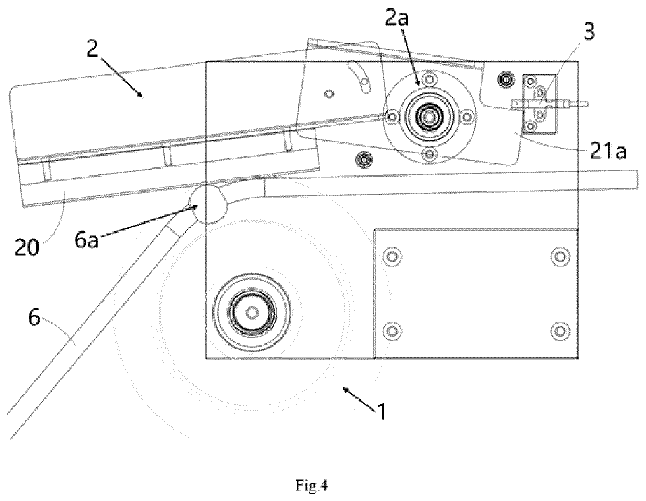

In the exemplary embodiment and as shown in FIGS. 1 to 4, a wire nodule detection device is disclosed. The wire nodule detection device comprises a rotating wheel 1, a swing arm 2 and a sensor 3. The swing arm 2 comprises a pressing portion 20 adapted to press a conveyed wire 6 against the rotating wheel 1. The sensor 3 is used for detecting a position of the swing arm 2. When a nodule 6a on the conveyed wire 6 passes between the rotating wheel 1 and the pressing portion 20 of the swing arm 2, the swing arm 2 swings back and forth once between a first position and a second position, allowing the presence of a nodule 6a on the conveyed wire 6 to be determined based on detecting of the position by the sensor 3.

In the exemplary embodiment and as shown in FIGS. 1 to 4, as illustrated since the size of the nodule 6a is larger than the diameter of the wire 6, this will result in the swing arm 2 being first swung from a first position (initial position) to a second position and then from the second position to the first position under the action of the nodule 6a, as the nodule 6a passes between the rotating wheel 1 and the pressing portion 20 of the swing arm 2. Thus, in the present application, once the swing arm 2 is detected to be swung to the second position, it can be determined that there is a nodule 6a in the wire 6. In the illustrated embodiment, the wire 6 is a broadly defined wire, which may comprise any wire-like material, e.g. the wire 6 may be a cable, a hollow tube or an optical fiber.

In the exemplary embodiment and as shown in FIGS. 1 to 4, in the illustrated embodiment, the wire nodule detection device further comprises a determining device. The determining device can be a software-integrated functional device, e.g., an industrial personal computer. The determining device communicates with the sensor 3 and can determine the presence of a nodule 6a on the conveyed wire 6 based on detecting of the position by the sensor 3. In the present application, once the sensor 3 detects that the swing arm 2 is swung to the second position, the determining device determines that a nodule 6a is present on the wire 6.

In the exemplary embodiment and as shown in FIGS. 1 to 4, in the illustrated embodiment, when no nodule 6a is present on the conveyed wire 6, the swing arm 2 remains in the first position throughout conveying of the wire 6. When the sensor 3 does not detect that the swing arm 2 is swung to the second position during the conveying of the wire 6, the determining device determines that no nodule 6a is present on the conveyed wire 6.

In the exemplary embodiment and as shown in FIGS. 1 to 4, in the illustrated embodiment, when a nodule 6a is present on the conveyed wire 6, the swing arm 2 is first swung from the first position to the second position and then swung from the second position to the first position under the action of the nodule 6a. When the sensor 3 detects that the swing arm 2 is swung to the second position during the conveying of the wire 6, the determining device determines that a nodule 6a is present on the conveyed wire 6.

In the exemplary embodiment and as shown in FIGS. 1 to 4, in the illustrated embodiment, the sensor 3 is a trigger switch, and the swing arm 2 has a trigger portion 21a for triggering the trigger switch. When the swing arm 2 is in the first position, the trigger portion 21a is in a non-triggering position in which the trigger switch is not triggered. When the swing arm 2 is in the second position, the trigger portion 21a is in a triggering position in which the trigger switch is triggered.

In the exemplary embodiment and as shown in FIGS. 1 to 4, in the illustrated embodiment, when the trigger switch is triggered during the conveying of the wire 6, the determining device determines that a nodule 6a is present on the conveyed wire 6. When the trigger switch is not triggered during the conveying of the wire 6, the determination device determines that no nodule 6a is present on the conveyed wire 6.

In the exemplary embodiment and as shown in FIGS. 1 to 4, in the illustrated embodiment, the sensor 3 can be a non-contact switch. For example, the sensor 3 is a photoelectric switch comprising a light emitter 31 and a light receiver 32 opposite the light emitter 31. When the light receiver 32 receives light emitted by the light emitter 31, the photoelectric switch is triggered.

In the exemplary embodiment and as shown in FIGS. 1 to 4, in the illustrated embodiment, when the swing arm 2 is in the first position, the light emitted by the light emitter 31 is blocked by the trigger portion 21a, preventing the light receiver 32 from receiving the light emitted by the light emitter 31. When the swing arm 2 is in the second position, the light emitted by the light emitter 31 is not blocked by the trigger portion 21a, allowing the light receiver 32 to receive the light emitted by the light emitter 31.

The present invention is not limited to the illustrated embodiment, for example, in another exemplary embodiment of the present invention, the sensor 3 is a photoelectric switch comprising a light emitter 31 and a light receiver 32 opposite the light emitter 31. When the light receiver 32 does not receive light emitted by the light emitter 31, the photoelectric switch is triggered. In this embodiment, when the swing arm 2 is in the first position, the light emitted by the light emitter 31 is not blocked by the trigger portion 21a, allowing the light receiver 32 to receive the light emitted by the light emitter 31. When the swing arm 2 is in the second position, the light emitted by the light emitter 31 is blocked by the trigger portion 21a, preventing the light receiver 32 from receiving the light emitted by the light emitter 31.

In another exemplary embodiment of the present invention, the sensor 3 is a contact switch. When the swing arm 2 is in the first position, the trigger portion 21a is separated from the contact switch; when the swing arm 2 is in the second position, the trigger portion 21a presses down the contact switch to trigger the contact switch.

In the exemplary embodiment and as shown in FIGS. 1 to 4, in the illustrated embodiment, the swing arm 2 is located above the rotating wheel 1, and the swing arm 2 is adapted to press the conveyed wire 6 against the rotating wheel 1 under its own weight. However, the present invention is not limited to the illustrated embodiment, for example, the wire nodule detection device can comprise an elastic element which exerts a predetermined pressing force on the swing arm 2, such that the swing arm 2 is adapted to press the conveyed wire 6 against the rotating wheel 1 under the action of the elastic element.

In the exemplary embodiment and as shown in FIGS. 1 to 4, in the illustrated embodiment, the wire nodule detection device further comprises a mounting plate 4. The mounting plate 4 is used for mounting the rotating wheel 1, the swing arm 2 and the sensor 3. The rotating wheel 1 is rotatably mounted on the mounting plate 4 and is rotatable about a first axis perpendicular to the mounting plate 4. The swing arm 2 is rotatably mounted on the mounting plate 4, and is capable of swinging about a second axis perpendicular to the mounting plate 4. The sensor 3 is fixed to the mounting plate 4.

In the exemplary embodiment and as shown in FIGS. 1 to 4, in the illustrated embodiment, the swing arm 2 further comprises a first arm 21 and a second arm 22. The first arm 21 is rotatably mounted to the mounting plate 4 by means of a rotation shaft 2a. The second arm 22 is fixed to one end of the first arm 21 and extends in a direction inclined to a direction of extension of the first arm 21. The trigger portion 21a is formed on the other end of the first arm 21, and the pressing portion 20 is fixed to a lower side of the second arm 22 or is integrally formed with the second arm 22.

In the exemplary embodiment and as shown in FIGS. 1 to 4, in the illustrated embodiment, the pressing portion 20 has a smooth contact surface for contacting the wire 6, so as to reduce a friction force between the pressing portion 20 and the wire 6 and to prevent the wire 6 from being worn by the pressing portion 20.

In the exemplary embodiment and as shown in FIGS. 1 to 4, in the illustrated embodiment, the wire nodule detection device further comprises a first limiting post 51 and a second limiting post 52. The first limiting post 51 is fixed to the mounting plate 4 for limiting the swing arm 2 to a first limit position. The second limiting post 52 is fixed to the mounting plate 4 for limiting the swing arm 2 to a second limit position. When the swing arm 2 swings between the first position and the second position, the swing arm 2 does not exceed the first limit position and the second limit position.

In the above exemplary embodiments according to the present invention, the wire nodule detection device can promptly identify a nodule on the conveyed wire, thus effectively preventing the problem of blockage caused by wire nodules.

It should be appreciated for those skilled in this art that the above embodiments are intended to be illustrative, and many modifications may be made to the above embodiments by those skilled in this art, and various features described in different embodiments may be freely combined with each other without conflicting in configuration or principle, and these variations are supposed to fall within the scope of protection of the present invention.

Although the present invention is described in conjunction with the accompanying drawings, the embodiments disclosed in the accompanying drawings are intended to exemplify embodiments of the present invention and are not to be construed as a limitation of the present invention.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

It should be noted that the word ‘including’ does not exclude other elements or steps, and the words “one” or ‘a’ do not exclude more than one. Furthermore, any element designation of the claims should not be construed as limiting the scope of the invention.

What is claimed is:

1. A wire nodule detection device, comprising:
a rotating wheel;
a swing arm having a pressing portion pressing a conveyed wire against the rotating wheel; and
a sensor detecting a position of the swing arm, when a nodule on the conveyed wire passes between the rotating wheel and the pressing portion of the swing arm, the swing arm swings between a first position and a second position, a presence of the nodule on the conveyed wire is determined based on the position detected by the sensor.

2. The wire nodule detection device of claim 1, further comprising a determining device determining the presence of the nodule on the conveyed wire based on the position detected by the sensor.

3. The wire nodule detection device of claim 2, wherein, when no nodule is present on the conveyed wire, the swing arm remains in the first position throughout conveying of the conveyed wire.

4. The wire nodule detection device of claim 3, wherein, when the sensor does not detect that the swing arm is swung to the second position during conveying of the conveyed wire, the determining device determines that no nodule is present on the conveyed wire.

5. The wire nodule detection device of claim 2, wherein, when the nodule is present on the conveyed wire, the swing arm is first swung from the first position to the second position and then swung from the second position to the first position under an action of the nodule.

6. The wire nodule detection device of claim 5, wherein when the sensor detects that the swing arm is swung to the second position during the conveying of the conveyed wire, the determining device determines that the nodule is present on the conveyed wire.

7. The wire nodule detection device of claim 2, wherein the sensor is a trigger switch, and the swing arm has a trigger portion for triggering the trigger switch, when the swing arm is in the first position, the trigger portion is in a non-triggering position in which the trigger switch is not triggered, when the swing arm is in the second position, the trigger portion is in a triggering position in which the trigger switch is triggered.

8. The wire nodule detection device of claim 7, wherein when the trigger switch is triggered during conveying of the conveyed wire, the determining device determines that the nodule is present on the conveyed wire, when the trigger switch is not triggered during the conveying of the conveyed wire, the determining device determines that no nodule is present on the conveyed wire.

9. The wire nodule detection device of claim 7, wherein the sensor is a photoelectric switch comprising a light emitter and a light receiver opposite the light emitter, and when the light receiver receives light emitted by the light emitter, the photoelectric switch is triggered.

10. The wire nodule detection device of claim 9, wherein when the swing arm is in the first position, the light emitted by the light emitter is blocked by the trigger portion, preventing the light receiver from receiving the light emitted by the light emitter, and when the swing arm is in the second position, the light emitted by the light emitter is not blocked by the trigger portion, allowing the light receiver to receive the light emitted by the light emitter.

11. The wire nodule detection device of claim 7, wherein the sensor is a photoelectric switch comprising a light emitter and a light receiver opposite the light emitter, and when the light receiver does not receive light emitted by the light emitter, the photoelectric switch is triggered.

12. The wire nodule detection device of claim 11, wherein when the swing arm is in the first position, the light emitted by the light emitter is not blocked by the trigger portion, allowing the light receiver to receive the light emitted by the light emitter, and when the swing arm is in the second position, the light emitted by the light emitter is blocked by the trigger portion, preventing the light receiver from receiving the light emitted by the light emitter.

13. The wire nodule detection device of claim 7, wherein the sensor is a contact switch, and when the swing arm is in the first position, the trigger portion is separated from the contact switch, and when the swing arm is in the second position, the trigger portion presses down the contact switch to trigger the contact switch.

14. The wire nodule detection device of claim 1, wherein the swing arm is located above the rotating wheel, and the swing arm presses the conveyed wire against the rotating wheel under its own weight.

15. The wire nodule detection device of claim 7, further comprising a mounting plate for mounting the rotating wheel, the swing arm, and the sensor, the rotating wheel is rotatably mounted on the mounting plate, and is rotatable about a first axis perpendicular to the mounting plate, the swing arm is rotatably mounted on the mounting plate, and swings about a second axis perpendicular to the mounting plate, the sensor is fixed to the mounting plate.

16. The wire nodule detection device of claim 15, wherein the swing arm further comprises a first arm rotatably mounted to the mounting plate by a rotation shaft, a second arm fixed to one end of the first arm and extending in a direction inclined to a direction of extension of the first arm, the trigger portion is formed on another end of the first arm, and the pressing portion is fixed to a lower side of the second arm or is integrally formed with the second arm.

17. The wire nodule detection device of claim 16, wherein the pressing portion has a smooth contact surface for contacting the conveyed wire, so as to reduce a friction force between the pressing portion and the conveyed wire and to prevent the conveyed wire from being worn by the pressing portion.

18. The wire nodule detection device of claim 16, further comprising a first limiting post fixed to the mounting plate for limiting the swing arm to a first limit position.

19. The wire nodule detection device of claim 18, further comprising a second limiting post fixed to the mounting plate for limiting the swing arm to a second limit position.

20. The wire nodule detection device of claim 19, wherein when the swing arm swings between the first position and the second position, the swing arm does not exceed the first limit position and the second limit position.
